(19) United States
(12) Patent Application Publication
(10) Pub. No.: US 2006/0084047 A1
(43) Pub. Date: Apr. 20, 2006

(54) System and method of segmented language learning

(75) Inventors: Chaucer Chiu, Taipei (TW); Xiao-Hui Shao, Shanghai (CN); Vicky Feng, Shanghai (CN)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 10/968,189

(22) Filed: Oct. 20, 2004

(51) Int. Cl. G09B 17/00; G09B 5/04

(52) U.S. Cl. 434/320; 434/178

(57) ABSTRACT

A system and method of segmented language learning is disclosed. The system filtered background noise of the audio information therein and obtained with audio information pausing position. The audio information will be segmented into at least one piece of segmented audio language learning data according to the audio information pausing position, and then generates an index. The system then plays the segmented audio language learning data according to the index for language learning.

### BACKGROUND OF THE INVENTION

1. Field of Invention

The invention pertains to a system and method of language learning, and particularly to a system of segmented language learning in which any audio information may be transformed into at least one piece of segmented language learning information as language learning material.

2. Related Art

With current electronic language learning systems, a corresponding pack of software is executed to provide the function of language learning. Such electronic language learning systems may be executed on a personal computer (PC), a personal assistant (PDA), an electronic dictionary and the like. As a whole, the function of language learning provided by these electronic language learning systems is usually achieved by pre-recording audio information corresponding to a specific language therein. Namely, sentences or vocabulary items of the specific language are pre-recorded in the electronic language systems. When the user operates such electronic systems, the sound of the sentences or vocabulary items of the language may be heard and the function of language learning may be thus achieved. Additionally, the electronic language learning system may provide a recording function so that the user may record and then listen to his or her own speech in that language, and thereby correct his or her pronunciation or reading of the language with the aid of the electronic language learning system.

The technologies associated with the language learning described above include, for example, patent U.S. Pat. No. 5,010,495. In the patent, the user may give controlling instructions according to those provided by the electronic language learning system to learn the language material therein by recording user-reading information corresponding to a reading after the played audio language learning material. There is another way applies the language learning, an evaluation function is provided by comparing pre-recorded information corresponding to the language learning material and recorded user-reading information corresponding to a reading, after the played audio language learning material and presenting a similarity according to the comparing result as a percentage form, such as that provided by a vocal accompaniment machine.

Although the prior art seems to operate reasonably and allows for language learning, the technologies therein are no more than a collection of the functions provided by a recorder, such as the play, pause and record functions. In other words, when using the electronic language learning system, the operations involve only playing the pre-recorded language learning information and recording the user-reading information. Furthermore, the user needs to keep the played pre-recorded language learning information in memory and then read the same information and then listen to the played reading information so that the user may judge on his/her own if his pronunciation and/or reading are correct. This learning scheme lacks an acceptable or objective standard in judgment of correctness of the user's pronunciation and reading.

Moreover, such language learning technology is provided based on the pre-recorded language learning information, and possible language learning information other than the language learning material provided by the language system may not be added and performed by the electronic system, such as information associated with news and movies, since information of this form may not be supported by the software built in the electronic language learning system and may not be played as desired. Specifically, the pre-recorded information is stored in the system in word or sentence units, and is only suitable to the situation where a series of language learning courses are provided, since the content of the courses may be played by linking a number of such word or sentence units. However, the information of news or movies is continuous and is without any similar segments, and is thus contradictory to the information format of the electronic language learning system. The user may only record some paragraphs, pause the recording operation manually, and then continue with recording the following paragraphs, which is always troublesome and not practical and efficient to the user. Therefore, the information of news or movies may not be added as language learning material based on the use of the current electronic language learning systems. In this regard, there is a need to provide an electronic language learning system that can support the functions of playing both audio information corresponding to language learning material recorded by a user and audio language learning information corresponding to the language learning material provided by the system.

### SUMMARY OF THE INVENTION

An object of the invention is therefore to provide a system and method of segment language learning in which any audio information may be analyzed and processed and then transformed into useful audio language learning information. The transformed audio language learning information may be played through a series of language learning operations by executing the corresponding software so that any audio information may be used as language learning material. This is more beneficial to the user.

To achieve the above object, the system of segmented language learning according to the invention comprises an audio information database storing audio language learning course information. An audio segment processing module reading a specific part of the audio language learning course information selected by the user from the audio information database. A learning process controlling and executing module reads the at least one piece of audio segment language learning information and comprising an audio information playing unit. An audio information recording module recording a reading by the user after the specific part of at least one piece of segmented audio language learning data is played. A user-reading audio data database stores the user-reading audio data. The Audio information analyzing and comparing module analyzing and comparing the user-reading audio data stored in the user-reading audio data database with the specific part of at least one piece of segmented audio language learning data.

The invention also provides a method of segmented language learning executed in the aforementioned system and operated on a platform supported by a computer. The method according to the invention comprises the steps of providing a list of language learning courses to be selected by a user; reading audio language learning course information corresponding to the selected language learning course from an audio information database; analyzing the audio language learning course information and filtering background noise therein; obtaining at least one audio information pausing position in the audio language learning course information; segmenting the filtered audio language learning course information into at least one piece of segmented audio language learning data according to at least one audio information pausing position; establishing an index to at least one piece of segmented audio language learning data and playing a specific part of at least one piece of segmented audio language learning data selected from the index.

The principle and technical content of the invention will be described in more detail in conjunction with the drawings provided below.

### BRIEF DESCRIPTION OF THE DRAWINGS

FIG. 1 is the schematic architecture of a system of segmented language learning according to the invention;

FIG. 2 is a flowchart of the method of segmented language learning according to the invention;

FIG. 3 is a flowchart of the first language learning information playing process of the method of segmented language learning according to the invention; and

FIG. 4 is a flowchart of the second language learning information playing process of the method of segmented language learning according to the invention.

### DETAILED DESCRIPTION OF THE INVENTION

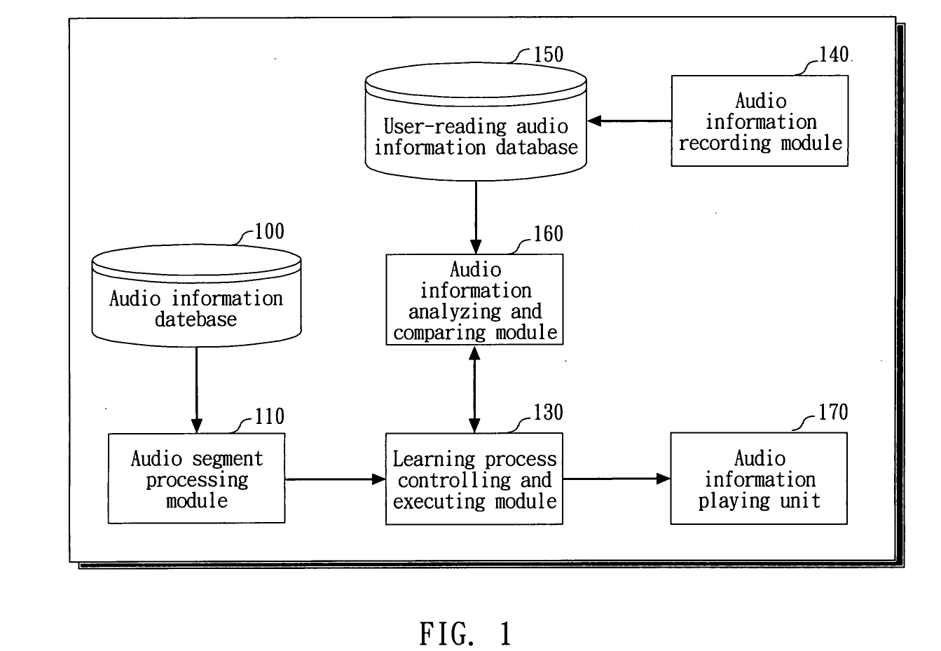

The invention discloses a system and method of segmented language learning in which the system is built into a personal computer (PC), a personal digital assistant (PDA) or an electronic dictionary. A schematic architecture of the system of segmented language learning according to the invention is illustrated in FIG. 1. Referring to FIG. 1, the system of language learning comprises:

(1) an audio information database 100 which is used to store at least one piece of audio language learning course information. The audio language learning course information comprises audio language learning course information pre-set in the system, and any audio information provided by a user such as news and movie-associated audio information termed herein as audio language learning user-course information.

(2) an audio segment processing module 110 which is used to read a specific part of the audio language learning course information selected by the user from the audio information database 100, segment the selected audio language learning course information into at least one piece of segmented audio language learning data, and establish an index to at least one piece of segmented audio language learning data.

(3) a learning process controlling and executing module 130 which is used to read a specific part of the segmented audio language learning data selected by a user from the index, comprising an audio information playing unit 170 that plays the specific part of the segmented audio language learning data.

(4) an audio information recording module 140 which is used to record user-reading audio data corresponding to a reading by the user after the specific part of the segmented audio language learning data is played by the audio information playing unit.

(5) a user-reading audio data database 150 which is used to store the user-reading audio data recorded by the user-reading audio data recording module 140.

(6) an audio information analyzing and comparing module 160 which is used to analyze and compare the user-reading audio data stored in the user-reading audio data database 150 with the specific part of the segmented audio language learning data read by the audio information controlling and executing module 130, and generate an language learning report.

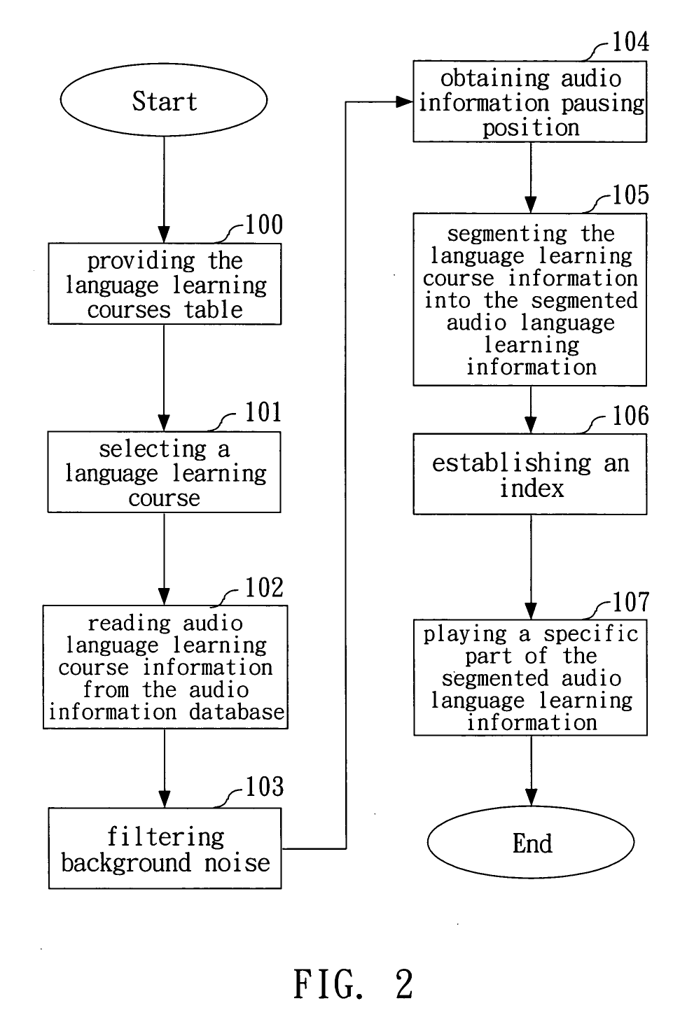

The method of language learning according to the invention is illustrated in FIG. 2.

First, the language learning courses table generated by the system are provided for the user (100), and the user selects a language learning course (101); then the system reads audio language learning course information corresponding to the selected language learning course from an audio information database (102); analyzing the audio language learning course information and filtering background noise therein (103); analyzing a pausing period and obtaining at least one audio information pausing position from the audio language learning course information (104); segmenting the filtered audio language learning course information into at least one piece of segmented audio language learning data according to the audio information pausing position (105); establishing an index according to segmented audio language learning data (106); and then, the system can playing a specific part of the segmented audio language learning data according to the index (107).

In practice, the technology of segmenting the audio language learning course information into at least one piece of segmented audio language learning data and establishing an index to the segmented audio language learning data may avoid the operations typically required with prior electronic language learning systems, in which a starting point and an ending point must be set for the user to learn a specific part of the audio material content. In the invention, other audio information may be inputted into the system and transformed into useful language learning information or materials through the technology of obtaining of the pausing position and segmenting audio language learning course information. Therefore, a more flexible learning environment with lively and diverse language learning content may be established.

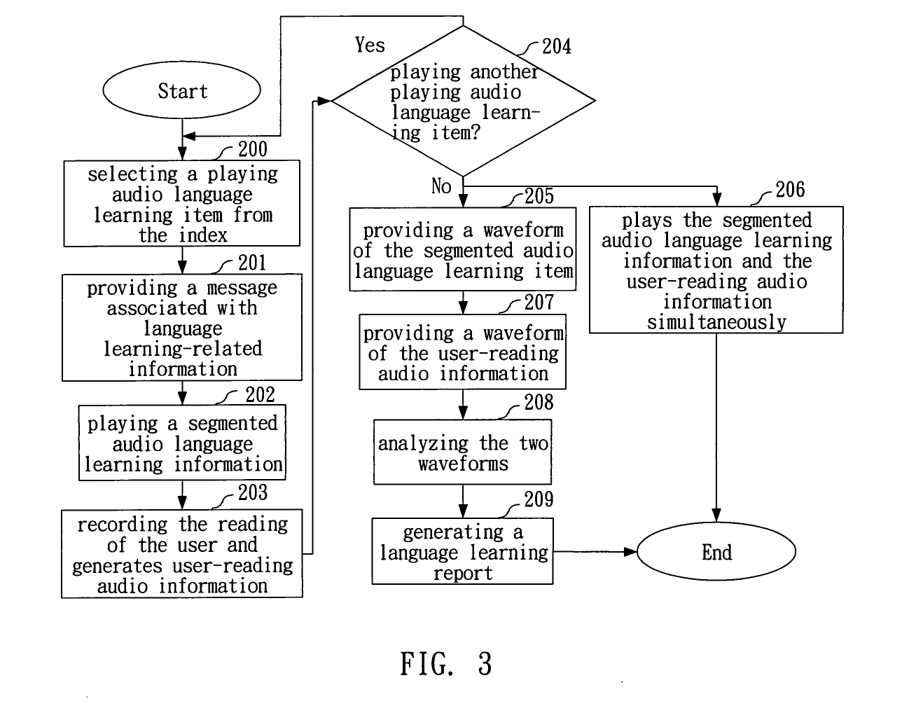

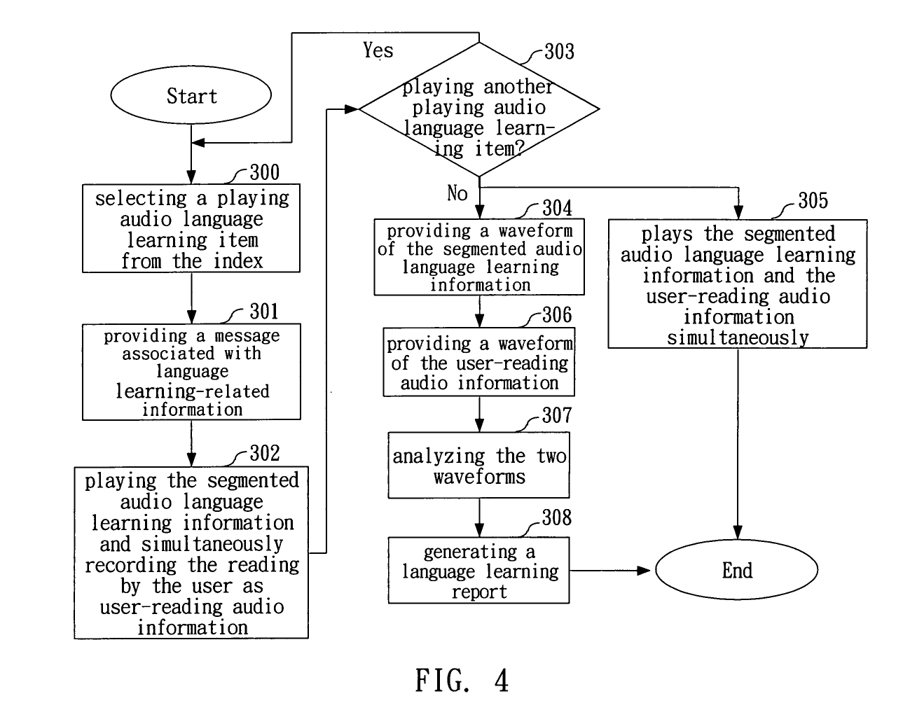

In step 107, playing the specific part of the segmented audio language learning data comprises some sub-steps. These sub-steps will be described as follows with reference to FIGS. 3 and 4, which correspond to a first and second audio language learning information playing processes respectively.

As shown in FIG. 3, the details of the step 107 will be explained below. First, selecting a playing audio language learning item from the index (200); and then, the system provides a message associated with language learning-related information (201) to inform the user that the selected item of segmented audio language learning data will begin, and directing the user to read aloud after the item of segmented audio language learning data is played. Next, the system plays a segmented audio language learning data corresponding to the selected playing audio language learning item (202). Thereafter, the system keeps silent for a period equal to the playing period of the selected item of segmented audio language learning data, and records the reading of the user and generates user-reading audio data (203). Then, the system verifies whether the user wishes to play another playing audio language learning item from the index (204).

If the user chooses to progress another playing audio language learning item, then the system returns to step 200. Otherwise, the system plays the selected item of segmented audio language learning data and simultaneously plays the user-reading audio data corresponding thereto (206), so that the user may hear the difference between the user-reading audio data of the user and the segmented audio language learning data, to correct his/her reading and pronunciation. Additionally, the system may provide a waveform of the selected segmented audio language learning item (205) and a waveform of the user-reading audio data corresponding thereto (207). Next, the two waveforms are analyzed and compared (208). Then, an evaluation is given as a percentage form according to the waveform similarity generated from the system, and a language learning report is generated according to the evaluation (209).

FIG. 4 illustrates a flowchart of another way of the language learning information playing process of step 107. First, a playing audio language learning item is selected by the user from the index (300). Next, a message associated with language learning-related information is issued (301) to inform the user that the selected item of segmented audio language learning data will begin to play, and the user should read aloud in the meantime. Then, a segmented audio language learning data corresponding to the selected playing audio language learning item is played by the system and the system simultaneously records the reading by the user as user-reading audio data (302). Then, the system verifies whether the user wishes to play another item of playing audio language learning item (303).

If the user chooses to progress another item of playing audio language learning item, then the system returns to step 300. If not, the system plays simultaneously the segmented audio language learning data and the user-reading audio data (305), so that the user may hear the difference between the segmented audio language learning data and the user-reading audio data, and correct his/her reading and pronunciation. Alternatively, the system may show a waveform of the segmented audio language learning data (304) and show a waveform of the user-reading audio data (306). Next, the two waveforms are analyzed and compared (307). Thereafter, an evaluation is given in a percentage form according to the waveform similarity generated from the system, and a language learning report is generated according to the evaluation for reference (308).

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A system of segmented language learning established on a platform which may be executed on a computer-implemented platform and providing a language learning operation according to a language learning course selected by a user, comprising:
an audio information database, which stores at least one piece of audio language learning course information;
an audio segment processing module, which reads one of the at least one piece of the audio language learning course information selected by the user from the audio information database, segmenting the audio language learning course information into a plurality pieces of segmented audio language learning data, and establishing an index according to the segmented audio language learning data;
a learning process controlling and executing module, which reads and plays the segmented audio language learning data according to the the index and the audio language learning course information;
a user-reading audio data database, which stores at least one of user-reading audio data; and
an audio information analyzing and comparing module, which analyzes and compares the user-reading audio data and the segmented audio language learning data, and then generates a language learning report.

2. The system of claim 1, further comprising an audio information recording module used to record the user-reading audio data.

3. The system of claim 1, wherein the learning process controlling and executing module comprises an audio information playing unit.

4. A method of segmented language learning which may be imbedded on a computer-implemented platform, comprising the steps of:
providing a language learning courses table;
selecting a language learning course from the language learning courses table;
reading an audio language learning course information corresponding to the selected language learning course from an audio information database;
analyzing the audio language learning course information and filtering a background noise therein;
analyzing the filtered audio language learning course information and obtaining at least one audio information pausing position therein;
segmenting the filtered audio language learning course information into at least one piece of segmented audio language learning data;
establishing an index according to the segmented audio language learning data; and
playing the segmented audio language learning data according the index.

5. The method of claim 4, wherein the playing step comprises the steps of:
(a) selecting a playing audio language learning item from the index;
(b) playing a segmented audio language learning data corresponding to the playing audio language learning item;
(c) recording a reading by the user as an user-reading audio data;
(d) proceeding the evaluation according to the difference between the segmented audio language learing information and the user-reading audio data.

6. The method of claim 5, wherein the step (a) further comprises a step of providing a message of language learning-related information.

7. The method of claim 5, wherein the step (d) further comprises a step of playing simultaneously the segmented audio language learning data and the user-reading audio data.

8. The method of claim 5, wherein the conducting step further comprises the steps of:
showing a waveform of the segmented audio language learning data;
showing a waveform of the user-reading audio data;
analyzing and comparing a similarity of the waveforms of the segmented audio language learning data and the waveforms of the user-reading audio data; and
generating a language learning report.

9. The method of claim 8, wherein the language learning report is represented as a percentage form.

10. The method of claim 4, wherein the playing step further comprising:
(a). selecting a playing audio language learning item from the index;
(b). playing a segmented audio language learning data corresponding to the playing audio language learning item, and recording simultaneously a reading by the user as an user-reading audio data; and
(c). proceeding the evaluation according to the difference between the segmented audio language learing information and the user-reading audio data.

11. The method of claim 10, wherein the step (a) further comprises a step of providing a message of language learning-related information.

12. The method of 10, wherein the step (c) further comprises a step of playing simultaneously the segmented audio language learning data and the user-reading audio data.

13. The method of claim 10, wherein the step (c) further comprises the step of:
showing a waveform of the segmented audio language learning data;
showing a waveform of the user-reading audio data;
analyzing and comparing a similarity of the waveforms of the segmented audio language learning data and the waveforms of the user-reading audio data; and
generating a language learning report.

14. The method of claim 13, wherein the language learning report is represented as a percentage form.
